(19) United States
(12) Patent Application Publication
(10) Pub. No.: US 2009/0198548 A1
(43) Pub. Date: Aug. 6, 2009

(54) SYSTEM TO AVOID POLICY-BASED DEADLOCKS IN WORKFLOW EXECUTION

(76) Inventors: Mathias Kohler, Stutensee (DE); Andreas Schaad, Karlsruhe (DE)

Correspondence Address: SCHWEGMAN, LUNDBERG & WOESSNER/SAP, P.O. BOX 2938, MINNEAPOLIS, MN, 55402, US

(21) Appl. No.: 12/025,889

(22) Filed: Feb. 5, 2008

(51) Int. Cl. G06Q 10/00; G06F 17/00

(52) U.S. Cl. 705/8; 705/7

(57) ABSTRACT

A computer-implemented method avoids policy-based deadlocks in execution of a workflow. The method includes receiving information describing a workflow. The workflow includes tasks, roles, site of tasks and security constraints related to the tasks. A data structure, representative of relationships between the tasks and the security constraints is automatically generated. An automated, design-time evaluation is performed using the data structure to determine a minimal number of resources to be assigned to the roles in order to execute the tasks of the workflow, and to avoid deadlock in execution of the tasks of the workflow as a result of security constraints.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008, SAP A.G., All Rights Reserved.

### BACKGROUND

A workflow may represent a reliably repeatable pattern of activity, and may be deployed to achieve processing intentions of some sort (e.g., a physical transformation, a service provision, or information process). Workflows may describe a process and be defined in terms of a number of tasks, to which resources may be allocated.

Workflow “deadlocks” when the execution of a process or task of a workflow is blocked, and cannot properly be terminated or completed (e.g., without administrative intervention). Deadlock situations may arise when certain requirements associated with the workflow cannot be satisfied. If such requirements are based on one or more policies applicable to the workflow, such deadlocks may be termed “policy-based deadlocks.”

### BRIEF DESCRIPTION OF DRAWINGS

Some embodiments are illustrated by way of example and not limitation in the figures of the accompanying drawings in which:

FIG. 1 is a block diagram showing an example workflow that includes three activities.

FIG. 2 is a block diagram illustrating an architecture of a system, according to an example embodiment.

FIG. 3 is a flow diagram illustrating flow charts illustrating methods, according to an example embodiment, of resource identification for a workflow.

FIG. 4 is a workflow diagram illustrating a workflow, according to an example embodiment, including four distinct activities that are the tasks defining a workflow.

FIG. 5 is a diagrammatic representation of an example application of a method to the workflow illustrated in FIG. 4.

FIGS. 6-8 illustrate an example application of the described methods and systems to a process employed within a legal information system.

FIG. 9 is a block diagram of machine, in the example form of a computer system, within which instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Example computer-implemented methods and systems for avoiding policy-based deadlocks and the execution of workflows are described below. In one example embodiment, a computer-implemented method includes retrieving (e.g., from a memory associated with a computer system) information describing a workflow. The workflow may include tasks, roles assigned to the tasks, and security constraints related to the tasks. A workflows may contain branches and therefore parallel executions of tasks in an arbitrary order during run-time may be specified (e.g., as a non-linear workflow). A data structure (e.g., a constraint-based relation graph) may be generated to represent relationships between the tasks and the security constraints (e.g., the assignment of various security constraints to one or more tasks of the workflow).

An automated, design-time evaluation is then performed, using the data structure, to determine a minimal number of resources to be assigned to the roles and tasks, in order to execute the tasks of the workflow in a manner that avoids deadlock as a result of the security constraints.

In one example, the workflow describes a business process, the tasks are business processes activities and the security constraints may be separation of duty constraints or binding of the duty constraints.

The automated generation of the data structure may include reflecting, in the data structure, relationships between first and second tasks of the workflow having a common security constraint. Further, the automated generation of the data structure may include removing a security constraint between at least two tasks of the workflow, where different roles have been assigned to each of these tasks.

The automated generation of the data structure may also include identifying multiple role assignments with respected to a task of the workflow, and then generating multiple data structures (e.g., a set of graphs), each graph representing a single role assignment of the multiple role assignments with respect to a particular task of the workflow.

The performance of the automated, design-time evaluation includes applying at least one of graph coloring, general operations research or search algorithms to each graph of the set of graphs to identify resources to be assigned to each role. The performance of the automated, design-time evaluation may also include generating a set of placeholder resources to be assigned to the tasks as placeholders for a later mapping of at run-time available resources.

In an example embodiment, at run-time, the method may include performing a determination whether the minimum number of resources is available to be assigned to the roles and tasks in order to avoid deadlock and, if so, then assigning actual resources to the relevant roles and tasks. The tasks of the workflow may then be executed at run-time, following the assignment of actual resources to the roles.

### Deadlocks

As mentioned above, deadlocks may describe a situation in which the execution of tasks of a workflow (or process) are blocked and cannot properly be terminated or completed. Deadlocks may occur due to requirements, pertaining to a workflow, which cannot be satisfied.

An example of a requirement that may apply with respect to a workflow is a security constraint, which may lead to a so-called “policy-based” deadlock. Examples of security constraints may include separation of duty (SoD) constraints or binding of duty (BoD) constraints. A separation of duty constraints may require that certain tasks or processes of a workflow, which are declared as exclusive, have to be performed by or using different resources (e.g., different users). The integration of such security constraints into a workflow may result in policy-based deadlocks, as the constraints imply the requirement that a certain number of resources (e.g. users) are available to perform the processes or tasks of a workflow. Consider a workflow having two exclusive tasks, which have to be performed by different users. In this situation, there will of course need to be at least two users to perform the tasks in order to be compliant with the constraint specifying that the tasks are exclusive and have to be performed by different users.

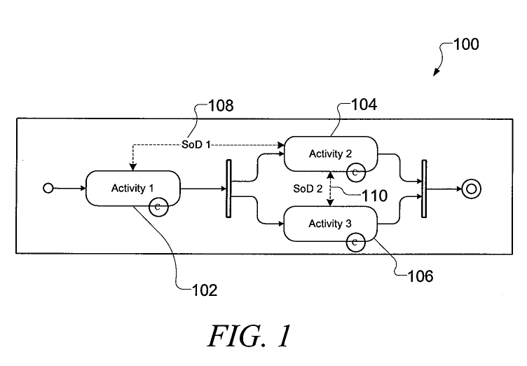

The confirmation of the amount or number of resources minimally needed to complete a workflow becomes substantially more complicated as the number of constraints applicable to the workflow increases. To illustrate this point, reference is made to FIG. 1, which shows an example workflow 100 that includes three activities 102, 104 and 106. Assume that resources in the example form of two users, namely Clerk A and Clerk B, are members of role “C” and that all of the activities 102-106 are required to be performed by members of this role. Hence, only two users are available to perform the three activities 102-106.

Further, assume that two separation of duty constraints 108 and 110 are defined with respect to the workflow. Separation of duty constraint 108 defines activities 102 and 104 as exclusive. Similarly, separation of duty constraint 110 defines activities 104 and 106 as exclusive. Accordingly, neither activities 102 and 104, nor activities 104 and 106, may be performed by the same user.

During execution of the workflow 100, assume that Clerk A performed activity 102. Due to the separation of duty constraints 108, Clerk A is now prohibited from performing activity 104. Assume, again for the purposes of example that Clerk B decides to perform activity 106 next. Due to the separation of duty constraint 110, Clerk B is also prohibited from performing activity 104. Accordingly, this presents a situation in which the workflow 100 is deadlocked, as neither of the users (Clerk A and Clerk B) has authority to perform activity 104, nor is there any further user available in the role “C” to perform this activity. Hence, the workflow 100 cannot be complete without violating one of the separation of duty constraints 108, 110, or some other administrative interaction.

Nonetheless, with a proper allocation of resources to roles (e.g., clerks to the “C” role) and tasks, the workflow 100 can complete without deadlock occurring. This requires an alternative assignment of users to the activities 102-106. Specifically, for a deadlock free execution of the workflow 100, Clerk A should perform activities 102 and 106, whereas Clerk B should perform activity 104. Clearly, in this case, none of the separation of duty constraints 108 and 110 will be violated, and the workflow 100 may successfully terminate.

In order to avoid deadlocks, such as that described above, it is useful to know the number, amount or quantity of resources (e.g., users) minimally needed to perform and complete a particular workflow. The above example shows that the ability to achieve a deadlock-free performance of a workflow may also be dependent upon specific resource-task assignments. One approach is to simulate every possible resource-task assignment for a process or workflow, and in this way determine whether the workflow can be completed in a deadlock free manner. However, the performance of such a “brute force” series of simulations becomes increasingly difficult as the quantity of resources (e.g., a number of users) which may perform the tasks of a process increases. Further, every time a particular resource becomes available or unavailable (e.g., a user joins or leaves a set of users), new simulations and calculations are required.

An example embodiment that provides a way to determine an exact number, amount or quantity of resources (e.g., users) to perform a process (e.g., described by a workflow), without making any assumptions regarding the actual or real resources that may be available at run-time (e.g., a set of users that may be available). An example embodiment may be utilized to determine, at design-time, an amount, quantity or number of resources (e.g., number of users) that are needed at a minimum to perform a given process, without encountering a deadlock situation. An example embodiment also seeks to provide an optimal resource-task assignment, while obeying a minimal resource/least privilege requirement. This is done without having to rely on run-time user data and without the need to perform recalculation should the run-time resource data change.

To this end, the example method and systems described herein seek to identify resource allocations to tasks, during the execution of a workflow, that avoid deadlock situations. In the example embodiment, this includes determining a resource allocation for a task or activity, while at the same time attempting to avoid unnecessarily binding of specific resources to specific tasks. This provides, on the one hand, a minimal amount of quantity of resources (e.g., a number of users) needed to execute a workflow and, on the other hand, as the resource-task allocation may be run-time context independent, it can be determined without relying on actual information describing resources available for execution of the workflow at run-time.

Accordingly, only at run-time when a workflow (e.g., to implement a business process) has to be executed, does a generically evaluated minimal number, amount or quantity of resources needed to be compared to an actual, available number, amount or quantity of resources. Assuming there are sufficient resources available, a deadlock free execution of the workflow may be performed utilizing the determined optimal resource-task assignment.

Considering an example in which a business process is modeled as a workflow, security constraints associated with the workflow may be transformed into an undirected constraint-based relationship graph, which represents the relations between the security constraints and tasks (e.g., business process activities). This undirected graph may provide the basis for further processing.

Subsequent operations include an actual evaluation, during which a minimal quantity or amount of resources to perform the workflow is determined, and resource-task allocations or assignments are evaluated.

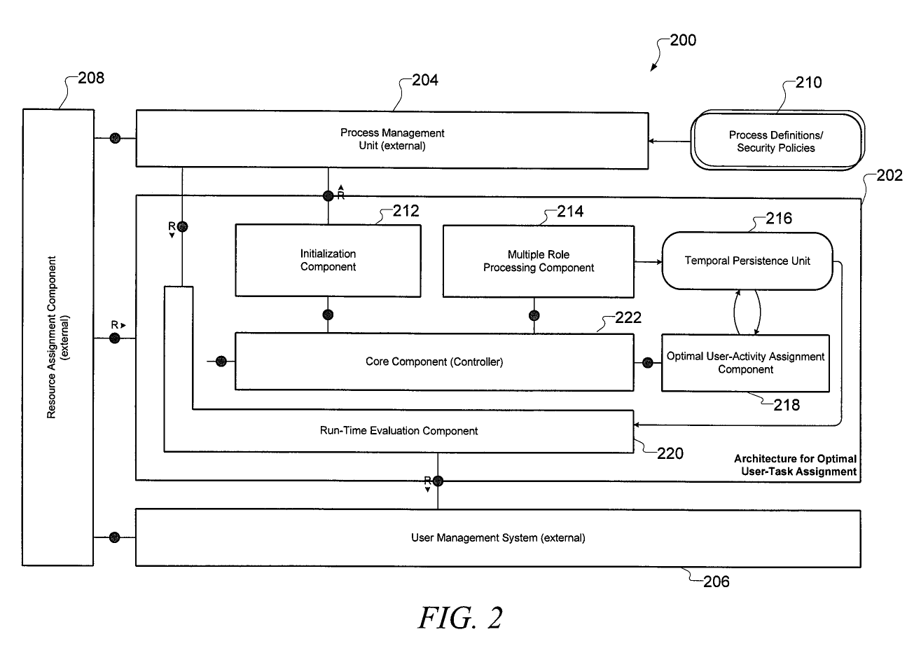

Further details regarding example embodiments of the above described methods will be provided below. To provide context for the example methods discussed below, it is useful to consider an example architecture that may be utilized to support and implement these methods. FIG. 2 is a block diagram illustrating an architecture of a system 200, according to an example embodiment, which may be utilized to implement the methods described herein. The example system 200 includes a resource-task assignment component, in the example form of a user-task assignment module 202, which is communicatively coupled to a process management unit 204, a user management system 206 and a resource assignment component 208. The process management unit 204 receives, as input, workflow information 210, that includes tasks (e.g., process definitions), roles assigned to the tasks and security constraints (e.g., security policies), and then operates to manage execution of the workflow, based on the workflow information 210.

An initialization component 212 of the module 202 is communicatively coupled to the process management unit 204, and receives the workflow information 210 (e.g., a workflow specification), and operatively transforms the workflow information 210 to a suitable data structure for processing. This data structure is representative of relationships between tasks and security constraints, while also reflecting resource assignments with respect to relevant tasks. Accordingly, in one embodiment, the initialization component 212 may be used to generate, based on the workflow information 210, an undirected constraint-based relationship graph that reflects the relationships between security constraints and tasks.

A multiple role processing component 214 is responsible for identifying multiple role assignments with respect to each task of the workflow, identified in the workflow information 210, and for generating multiple data structures (e.g., a set of graphs) based on the data structure (e.g., the undirected constraint-based relationship graph) outputted by the initialization component 212. Each of these multiple data structures may, as will be described in further detail below, represent a single role assignment, of multiple role assignments, with respect to specific tasks of a workflow.

The set of graphs generated by the multiple role processing component 214 are temporarily stored in a temporal persistence unit 216 for later evaluation by an optimal user-activity assignment component 218.

The temporal persistence unit 216, in addition to being communicatively coupled to the component 214, is also communicatively coupled to a run-time evaluation component 220, which is also communicatively coupled to the process management unit 204. The run-time evaluation component 220 performs a run-time check to determine whether a minimal number of resources is available to be assigned to roles in order to avoid deadlock in execution of tasks of the workflow. To this end, the run-time evaluation component 220 is also shown to be communicatively coupled to the user management system 206 to retrieve current resource information (e.g., a number of users that are available for allocation or assignment to a particular role within a workflow). The run-time evaluation component 220 is also communicatively coupled to the process management unit 204 to retrieve workflow information 210.

In an example embodiment, operations of the user-task assignment module 202 may be externally triggered by the resource assignment component 208, and operations of the user-task assignment module 202 may be internally managed by a core component 222, which is communicatively coupled to the components 212, 214, 218 and 220.

Further details regarding the various operations and functions of the components described with reference to FIG. 2 are provided below.

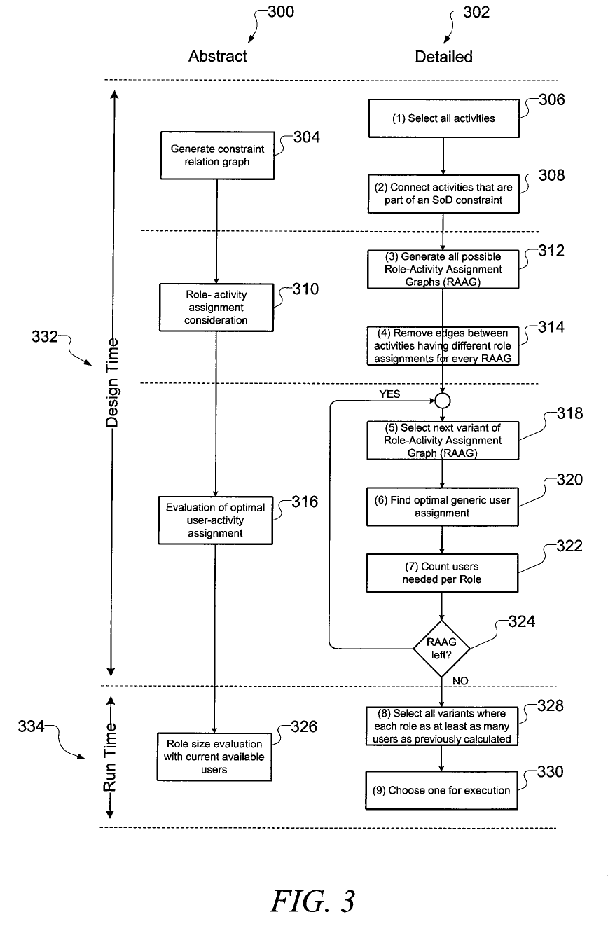

FIG. 3 is a flow diagram illustrating a first flow chart providing an abstract view of a method 300, according to an example embodiment, of resource identification for a workflow. FIG. 3 also illustrates a second flowchart illustrating a more detailed method 302, according to an example embodiment, to determine resources for deadlock-free execution of tasks of a workflow.

The example methods 300 and 302 seek to avoid deadlocks in the execution of a workflow by determining minimal resources needed to complete a process described by a workflow. Consider that if a workflow describes no security constraints, and every user (as examples of resources) of a set of users has permission to perform every activity or task of a given workflow, the minimal number of needed users to perform and finish the workflow would be one, as one user could perform all activities. The number of users increases, and may even vary, if access control constraints (e.g., separation of duty constraints) are part of a workflow's security policy. Considering, for example, the simple workflow described above with reference to FIG. 1, a minimum of two users are necessary to complete that process. Even more users would be needed without an optimal user-activity assignment.

It will be appreciated that, absent an analysis of a given workflow, it is unknown whether an available resource capacity (e.g., a number of users) is sufficient to complete a workflow, or what may be an optimal resource-task (e.g., user-activity) assignment. Accordingly, the example methods 300 and 302 seek to determine a minimal resource quantity (e.g., a number of users) for deadlock-free workflow execution. The methods 300 and 302, in the example embodiments, also provide a determination of a resource-task (e.g., user-activity) assignment.

It will also be noted that the example methods 300 and 302 are described within the context of workflows prepared for access control enforcement. For example, users may be grouped into roles (e.g., the above described “C” clerk role) and the roles are provided with permissions to perform certain activities (e.g., by role-activity assignments). The methods 300 and 302 may be deployed to process workflows using multiple roles for access controls, and seek to determine a minimal number of users to be assigned to every role of a particular workflow. Further, in cases where multiple roles have permissions to perform a certain activity, these permissions are also factored into the methods. The methods are however not limited to workflows relating to access control enforcement, and may be applied with respect to any process descriptions (e.g., workflows) which provide constraints with respect to tasks, and also specify certain resource allocations to tasks. As such, the term “roles” is not limited to the allocation of user resources to a particular task, but should be broadly understood to relate to the identification of any resource type, which may in turn be assigned to a task. For example, a resource may comprise a system, an equipment item, a location resource (e.g., a conference room or other work area), funds, time or materials.

Both the abstract and detailed methods 300 and 302 are shown, at a high level, to be designated as including operations to be performed at design-time 332 and at run-time 334. Input, according to an example embodiment, to each of the methods 300 and 302 may include the following:
1. Tasks, in the example form of a set of distinct activities (A);
2. Resource identifiers, in the example form of a set of distinct roles (R);
3. Resource-task assignments, in the example form of role-activity assignments (RAA) where every role (r) is assigned to at least one possibly several activities (a); and
4. Resource constraints, in the example form of a set of separation of duty (SoD) constraints (C).

At operation 304 of the method 300, the initialization component 212 performs a process initialization that includes generating a data structure, in the example form of an undirected constraint-based relationship graph, which is suitable for processing at operations 310 and 316. In a specific example, the initialization component 212 may receive workflow information 210, from the process management unit 204. The workflow information 210 identifies a set of activities and a set of duty constraints. At operation 306, the initialization component 212 may select all activities from a set of activities, and at operation 308 generates the constraint-based relationship graph such that nodes representing activities within the graph, which have a common separation of duty constraint, are connected. In this way, the connections between the nodes, representing the activities having a common separation of duty constraint, express a constraint relationship between the relevant activities.

Operation 310, in an example embodiment, is performed by the multiple role processing component 214 and takes multiple role usage, with respect to activities of a workflow, into consideration. Specifically, at operation 310, the multiple role processing component 214 identifies multiple role assignments with respect to each activity within the set of activities identified in the workflow information 210, and, utilizing the constraint-based relationship graph generated at operation 304, generates multiple data structures. Each of these multiple data structures represents a single role assignment configuration with respect to the set of activities of the workflow. Consider that, for the final workflow execution, a single user (who is actually performing an activity) will be a member of a set of roles upon which no constraints are specified. However, if there are multiple roles assigned to a single activity, this provides various possibilities for membership of the actual user. This opens several variants for the final role-activity assignment, all of which may be considered at operation 310.

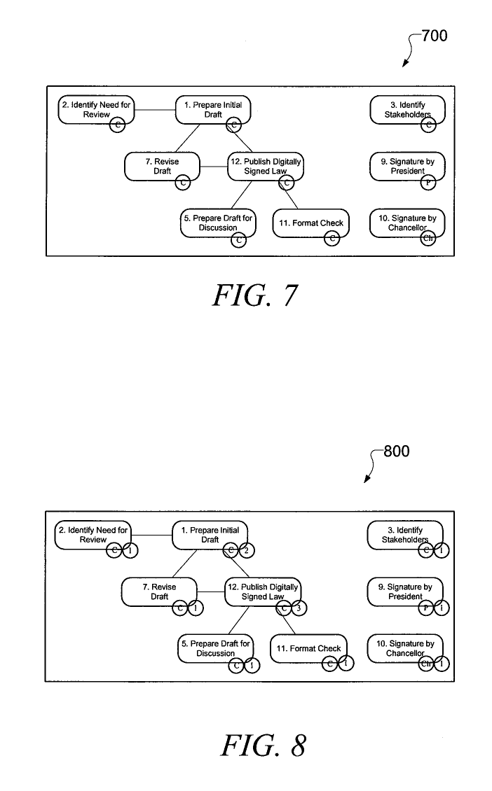

In an example embodiment, the multiple role processing component 214 may, based on the constraint-based relationship graph generated at operation 304, generate all possible role-activity assignment graphs (RAAGs). At operation 314, the component 214 may then, for every role-activity assignment graph, remove “edges” between activities having different role assignments. Examples of the removal of “edges” in this manner are described below with reference to FIG. 6.

Moving on to operation 316, the run optimal user-activity assignment component 218 performs an evaluation of user-activity assignments, using the multiple data structures outputted from the multiple role processing component 214 to the temporal persistence unit 216. Specifically, at operation 316, the optimal user-activity assignment component 218 seeks to calculate an optimal solution for every role-activity assignment generated at operation 310. In an example embodiment, an “optimal” solution may be a solution that determines a minimum number of users needed to perform the process, described at the workflow information 210, in a deadlock free-manner.

In an example embodiment, the evaluation performed at operation 316 may compromise one or more iterations of operations 318-324 of the detailed method 302. Specifically, at operation 318, the component 218 may identify and select a next variant of a set of role-activity assignment graphs stored within the temporal persistence unit 216.

At operation 302, the component 218 may determine a minimal generic user-activity assignment with respect to the specific role-activity assignment graph.

At operation 322, the component 218 may then count the number of users required per role in order to satisfy the generic user-activity assignment determined at operation 320.

At decision block 324, the component 218 may determine whether any role-activity assignment graphs, stored within the temporal persistence unit 216, remain unexamined and unprocessed. If so, the method 302 loops back to operation 318. On the other hand, if the component 218 determines that all role-activity assignment graphs within the temporal persistence unit 216 have been processed, the method 302 progresses.

Accordingly, the output of operation 316 is multiple “minimum” user-activity assignments, one for each role assignment variant determined at operation 310. Each of these “minimum” user-activity assignments, outputted at operation 316, is run-time context independent. Accordingly, at run-time 334, the run-time evaluation component 220, at operation 326, performs a role size evaluation, given currently available users that are available at run-time. Specifically, in one example embodiment, the run-time evaluation component 220 may, at operation 328, identify any or all role-activity assignment graphs (each representing a role-assignment variant) where there are a sufficient number of currently available users to satisfy the counted users per role (as determined at operation 322). If a role-activity assignment graph for a particular variant requires more than a currently available number of users for a particular role, this role-activity assignment graph may be excluded at operation 328.

At operation 330, the run-time evaluation component 220 may then select a particular role-activity assignment graph, of the graphs selected at operation 328, for execution, and assign actual resources (e.g., currently available users) to the roles identified by the selected role-activity assignment graph. Operation 330 may include mapping currently available users to placeholder (e.g., imaginary) users used for the evaluation.

The choice of which role-activity assignment variant to select at operation 330 may be made automatically, by the run-time evaluation component 220, based on various criteria. For example, a simple selection of a variant which requires a minimum number of users may be performed. In the event that multiple variants require the same number of users, other factors may be utilized to select a particular variant. For example, a previous utilization of users, the reputation of skill level of users, etc may be considered in assessing which variant to select.

Following the choice of a particular variant, represented by a role-activity assignment graph, the selected variant may be communicated from the run-time evaluation component to the process management unit 204, which may then proceed to manage execution of the workflow based on the selected variant of role-activity assignments, and assigned actual resources (e.g., users assigned to roles).

The example methods 300/302 may be advantageous in one aspect in that optimal (e.g., minimum) user-activity assignments are performed independent of run-time available resources (e.g., users), which makes it feasible to perform at least a portion of an evaluation (in order to determine a minimum number of resources for a deadlock free execution) at design-time of a workflow process, as opposed to requiring that the entire evaluation be perform at run-time. The example methods 300/302 accordingly only require that the actual resource-role assignments be performed at run-time 334, based on currently available actual resources. Accordingly, the computational demands made on a system, such as the system 200, at run-time may be reduced, by performing at least part of the overall evaluation at design-time 332. Accordingly, in an example embodiment, the example methods enable the determination of a generic execution plan, which can be generated once during design-time of a business process. An advantage is also that this generic execution plan may remain valid, even if the members of the roles change.

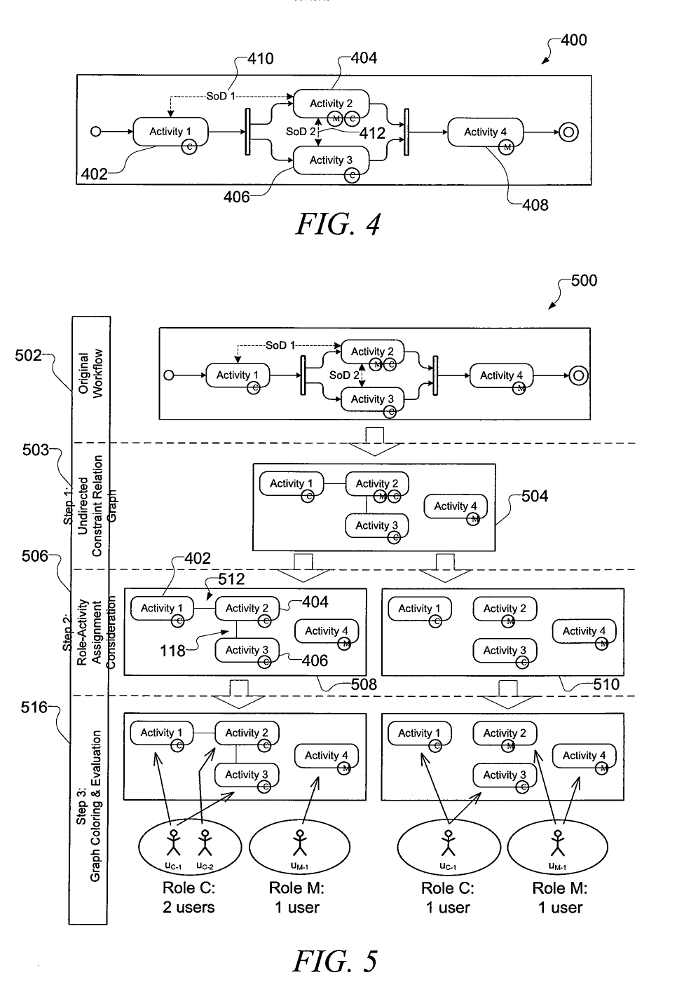

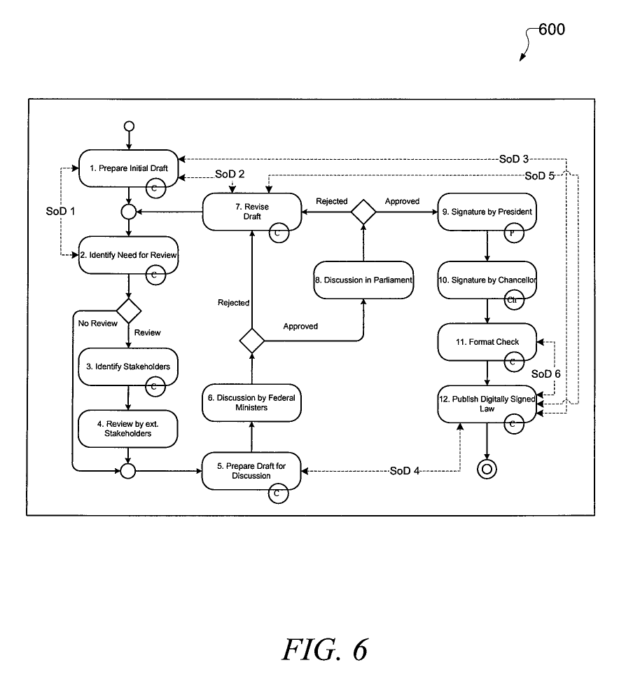

A specific example of the method 302, as applied to with respect to a specific workflow, will now be describe with reference to FIGS. 4 and 5. FIG. 4 is a workflow diagram illustrating a workflow 400 including four distinct activities 402-408, which are the tasks defining the workflow 400.

Users constitute example resources needed to perform the activities 402-408 of the workflow 400, and again all of the users, in the example, are distinct.

Within the context of the workflow 400, a “role” is a context, such that all roles are distinct. A user can be assigned to a role, and a role can be assigned to one or more of the activities 402-408. Each user assigned to a role has permissions to perform the activities which the role is assigned.

A user-role assignment (URA), in an example embodiment, is a set of relations reflecting which user is assigned to which role. For example, a user (uᵢ) that is a member of a role (rₓ) is called a registered user (uᵣ_{ₓ}₋ᵢ). We further assume that one user is assigned at most to one role.

A role-activity assignment (RAA) is, an example embodiment, a set of relations reflecting that a role (rₓ) is assigned to an activity (aₖ).

A user-activity assignment (UAA) is, in an example embodiment, a set of relations reflecting a registered user (uᵣ₋ᵢ) is assigned to perform an activity (aₖ).

A separation of duty (SoD) constraint is, in an example embodiment, a relation between two activities (a₁ and a₂). It may be denoted by a₁ [symbol] a₂, and restricts the assignment of registered users to an activity, such that a₁ and a₂ must be performed by different registered users.

An information describing a workflow (e.g., the workflow information 210) received by the process management unit with respect to the workflow 400 may include the following:
1. A set of distinct activities (A);
2. A set of distinct roles (R);
3. A set of role-activity assignments (RAA), where every role (rₓ) is assigned to at least one but possibly to several activities;
4. A set of separation of duty (SoD) constraints (C).

The workflow 400 shown in FIG. 4 is an extended version of the workflow 100 shown in FIG. 1 and has four activities 402-408. The process described by the workflow commences with activity 402, then splits for parallel execution of activities 404 and 406 to eventually finish with activity 408. There are two separation of duty constraints, namely constraints 410 and 412. Furthermore, each activity is annotated to show what members of which roles have permission to perform the relevant activity. Accordingly, activities 402, 404 and 406 may be performed by members of the role “C”. Activities 404 and 408 may also be performed by members of the role “M”. The method 302 may be performed, by the system 200 to determine an assignment of registered users (uᵣ_{ₓ}₋ᵢ) to activities in such a way that no user is assigned to two activities aₖ, a₁ [symbol] A if there is a SoD constraint aₖ [symbol] a₁ε C and that the number of registered users needed is minimal.

Accordingly, the workflow presents a situation in which more than one role is assigned to an activity (e.g., the roles “C” and “M” are assigned to activity 404).

Dealing generally with the situation of a workflow that has multiple role assignments for a particular activity, it will be appreciated that during workflow execution, this has the result that users of different roles can perform the relevant activity. If more than one role is assigned to an activity, the cardinality of the set of roles (R) assigned to an activity is “greater 1”. This is the case for activity 404. Whether the activity 404 is performed by a registered user of role “C” or a registered user of role “M” affects the minimum number of users needed per role.

Considering the separation of duty (SoD) constraints 410 and 412 with respect to the workflow 400, as long as activity 404 is performed by a registered user of role “C”, activities 402 and 404 have to be performed by different users of role “C”. Hence, role “C” needs to have at least two members. On the other hand, if activity 404 is performed by a registered user of role “M”, the situation changes. Since we assume that no user is a member of more than one role, there is no chance that the same user is assigned exclusively to activities 402 and 404, or activities 404 and 406. Hence, in this case, the minimal needed number of registered users for role “C” is only one.

In summary, the number of minimally needed users per role depends on the role a user is considered to be a member of during execution. This means there are multiple different variants of possible workflow executions, where each activity is assigned only a single role. As each of these variants represents a different possible role-activity assignment, and hence each of them has different minimal user requirements, each of these variants requires consideration for further processing. Let W={w₁, w₂, . . . , wₙ} be the set of workflow variants described above with n=|W| being the cardinality of variants. Further, let RA(R, aₖ):=|{(R, aₖ) | (R, aₖ) ε RAA} be the number of different roles R assigned to an activity aₖε A. Then, the number of different variants of workflows in W is

$$\vert W \vert = {\prod }_{k = 1}^{\vert A \vert} RA ( R , {α}_{k} ) \qquad ( 1 )$$

Consequently, as the methods 300/302 consider all variants of role-activity assignments for further processing, the output will be a minimal number of registered users for each of the n=|W| possible variants.

FIG. 5 is a diagrammatic representation of an application of a method 500 to the workflow 400 illustrated in FIG. 4. To this end, the method 500, illustrated in FIG. 5, utilizes as input workflow information describing the original workflow at operation 502. To eventually determine a minimal number of required users to ensure deadlock-free execution of the workflow, one example implementation of the operation 502 may utilize graph theory. Accordingly, at operation 502, elements of the original workflow 400, as reflected in the workflow information are transformed, by the initialization component 212, into an undirected graph 504, which represents the relations between the activities and the security constraints. The graph 504 accordingly provides an example of a constraint-based relationship graph. The elements of the graph 504 are the input elements contained in the workflow information provided to the initialization component 212, namely a set of activities, a set of role-activity assignments (which implicitly contain a set of roles), and a set of separation of duty constraints. The nodes of the graph 504 represent activities, and the edges represent separation of duty constraints. An example definition of the graph 504 is as follows:
Constraint-based Relation Graph: Let G=(A, C, RAA) be an undirected graph with

$$A = \{ {a}_{1} , {a}_{2} , … , {a}_{n} \} being the$$

$$set of vertices representing the activities , \\ C = \{ {c}_{1} , {c}_{2} , … , {c}_{m} \} being the set of edges representing the SoD constraints , \\ and$$

$$R A A = \{ ( {r}_{x} , {a}_{k} ) , … \} being the set of role \text{-} activity assignments with {r}_{x} ∈ R and {a}_{k} ∈ A$$

At operation 506, role-activity assignment considerations are performed. As stated above, for the workflow 400, different workflow variants are possible due to multiple, different role assignments with respect to the same activity (e.g., activity 404 as multiple role assignments). At operation 506, the undirected constraint-based relationship graph 504 is transformed into a set of graphs G′={G′₁, G′₂, . . . , G′ₙ}, such that each graph of a set of graphs has a different set of role-activity assignments, as well as at the most one role assignment per activity. The transformation of the graph 504 to a set of graphs 508, 510 is shown in FIG. 5. It will be noted that the graph 508 still includes edges 512 and 514, reflecting separation of duty constraints that exist between the activities 402, 404 and 406. However, with respect to graph 510, these “edges” representing the separation of duty constraints between activities have been removed. The edges for graph 510 can be removed based on the assumption that users assigned to two different roles will always be different, and accordingly that the separation of duty constraints for the variant represented by a particular graph (e.g., the graph 510) are redundant and do not need to be considered in further processing. Accordingly, with respect to the graphs 508 and 510, “edges” or connections between activities representing a separation of duty constraints only exist between activities which have the same role assigned.

The generation of the graph 510, from which “edges” between activities have been removed, accordingly provides an example of an operation 314 that may be performed as part of the method 302 described above with reference to FIG. 3.

At operation 516, an automated, design-time evaluation includes applying at least one of graph coloring, general operations research or search algorithms to each graph of the set of graphs to identify resources to be assigned to each role.

In an example embodiment, at operation 516, the graphs 508 and 510 are utilized to determine a (e.g., minimal) user-activity assignment. Specifically, an optimal user-activity assignment is performed at operation 516, by the optimal user-activity assignment component 218. In one example, the evaluation performed at operation 516 applies a graph coloring method to each of the graph variants 508 and 510. The characteristics of graph coloring applied to a graph 508 or 510 satisfy the requirements given by the separation of duty constraints. Each activity in a graph 508, 510 is assigned a number in such a way that no two adjacent activities have the same number. This corresponds to the separation of duty constraints, which require that users have to be assigned to activities in such a way that no two adjacent activities have the same user.

The component 218 attempts to identify a minimal number of users required to perform the activities of the workflow 400. Hence, the number of different users used for graph coloring is also minimal. In other words, the graph coloring and evaluation operation 516 takes a set of graphs (e.g., graphs 508 and 510) and generates a set of labeled graphs, where the labels (e.g., integer numbers) adhere to the constraint that no two adjacent activities have the same label, and the number of different labels used is minimal. A coloring of a graph is the basis for the final user-activity assignment.

Due to the coloring, there are a certain number of different colors (k) for every role (r) in a labeled graph. A final goal may be to generate, for each color (k) and for each role (r), a registered user (uᵣ₋ₖ) such that r represents the role and k represents the color. The registered user (uᵣ₋ₖ) is finally assigned to all activities which have assigned role (r) and have been colored (k). In the example illustrated in FIG. 5, the resulting user allocations for each of the graph variants 508 and 510 are shown. Specifically, for the graph variant 508, two users are shown to be allocated to role “C”, and one user is shown to be allocated to role “M”. For graph variant 510, a single user is shown to be allocated to role “C”, and a single user is also allocated to role “M”. The final evaluation regarding how many users are needed per role arises from the number of distinct users assigned to the colored graphs G″ᵢε G″. In particular, there is a set of user-activity assignments UAAᵢ for every graph G″ᵢε G″ and every user in UAAᵢ is registered to a particular and distinct role. The number of users in UAAᵢ is minimal. Consequently, the numbers of users registered for a certain role is minimal as well.

The performance of the automated, design-time evaluation at operation 516 may also include generating a set of placeholder resources (e.g., users uᵣ₋ₖ) to be assigned to the tasks as placeholders for a later mapping of at run-time available resources (e.g., as performed at operation 330 described above).

We below discuss an application of the example method 302 with respect to an electronic law update process, which is illustrated by the workflow diagram of FIG. 6. Specifically, FIG. 6 illustrates a process employed within a legal information system in Austria, where laws are managed as digitally signed electronic documents. One of the systems is called “eLaw”, which can, for example, be used to manage changes to existing laws. An update process implemented by the legal information system comprises 12 activities and its workflow is depicted in FIG. 6. A brief description of the workflow 600, and its associated access control constraints, is provided below. This is followed by a description of an approach to determine a minimal number of users needed per role, in accordance with the method 302 to complete the workflow 600, while avoiding a deadlock situation. In Activity 1 of the workflow 600, a law clerk proposes a draft of a new version of a law. This is followed by a decision, at Activity 2, whether there needs to be a review by an external stakeholder. If so, external stakeholders are identified in Activity 3, and asked for their review and comments in Activity 4. In Activity 5, a new draft (including comments from the reviewers) is prepared for discussion by federal ministers, this discussion occurring at Activity 6. If the draft is rejected by the ministers, it is revised at Activity 7. Otherwise, the draft is discussed by parliament at Activity 8. If the parliament approves the changes, the updated law is signed by the president at Activity 9 and by the Chancellor at Activity 10. Finally, a clerk does a final format check at Activity 11, and the new law is uploaded to the official information system at Activity 12.

Turning to Activity 8, should the draft be rejected by the federal ministers at Activity 6 or by parliament at Activity 8, the workflow returns to Activity 7 for revision.

The workflow 600 reflects six separation of duty constraints (SoD1-SoD6). For each activity of workflow 600 that is performed by a single internal user, FIG. 6 depicts a corresponding role. Most of the activities are assigned to the role CLERK which is abbreviated “C”. However, there are also two roles, namely Chancellor “Ch” and President “P”.

The separation of duty constraints illustrated in FIG. 6 prevents either accidental or intentionally malicious actions. For example, SoD1 prevents a clerk who initiates the changes in the law from being responsible for deciding about the need for review. Similarly, SoD2 ensures that, in case of a rejection by the ministers or the parliament, the clerk who initiated the draft at the beginning is a different person from the clerk that does the revision at Activity 7. This may be useful to ensure a fresh perspective. The remaining SoD constraints prevent clerks from modifying a document and also uploading such a document to the information system. The possible threat here is that clerk may use his or her right to modify a document and immediately upload it to the system, either accidentally or with malicious intent.

The first operation to determine the minimal needed users per role includes extracting the Constraint-based Relation Graph from the workflow definition. This is done by first selecting all relevant activities (e.g., operation 306 of method 302). For this scenario, only these activities which are relevant for the later user-activity assignment are considered. Hence all activities which have to be performed by a user during run-time. The set of activities A_{eLaw}, the set of SoD constraints C_{eLaw} and the set of role-activity assignment RAA_{eLaw} are as follows. These sets comprise the input for further processing.

$${A}_{eLaw} = \{ {a}_{1} , {a}_{2} , {a}_{3} , {a}_{5} , {a}_{7} , {a}_{9} , {a}_{10} , {a}_{11} , {a}_{12} \}$$

$${C}_{eLaw} = \{ ( {a}_{1} , {a}_{2} ) , ( {a}_{1} , {a}_{7} ) , ( {a}_{1} , {a}_{12} ) , ( {a}_{5} , {a}_{12} ) , ( {a}_{7} , {a}_{12} ) , ( {a}_{11} , {a}_{12} ) \}$$

$${RAA}_{eLaw} = \{ ( {r}_{C} , {a}_{1} ) , ( {r}_{C} , {a}_{2} ) , ( {r}_{C} , {a}_{3} ) , ( {r}_{C} , {a}_{5} ) , ( {r}_{C} , {a}_{7} ) , ( {r}_{C} , {a}_{11} ) , ( {r}_{C} , {a}_{12} ) , ( {r}_{P} , {a}_{9} ) , ( {r}_{Ch} , {a}_{10} ) \}$$

The accompanying graph G_{eLaw}=(A_{eLaw}, C_{eLaw}, RAA_{eLaw}) is depicted at 700 in FIG. 7 (e.g., the output of operation 308 of method 302).

The second operation is the role-activity assignment consideration ((e.g., operations 312 and 314 of method 302)). If there are activities that have more than one role assigned, these operation transform the graph G_{eLaw} into several graphs such that every graph has distinct role-activity assignments and no activity has more than one role assigned to it. As for this example, every activity in the Constraint-based Relation Graph G_{eLaw} has only one role assigned. Accordingly, the input graph is already the (complete) set G′_{eLaw} of output graphs (e.g., result of operation 312 of method 302).

We also have to remove all edges between activities assigned different roles. Also in this case there is nothing to remove, as all edges are solely between activities having the same role assigned (e.g., the result of operation 314 of method 302).

The third operation is to find an optimal user assignment per role for every graph in G′_{eLaw}. As there is only one graph in the set G′_{eLaw} we will concentrate on that (and select it as required by, for example, operation 318 of method 302)). This graph has three types of roles assigned to its activities, namely role Clerk, Chancellor, and President.

For the optimal user assignment ‘graph coloring’ is used. Hence, for every vertex in G′_{eLaw} a number iε N is assigned in such a way that no two connected vertices are assigned the same number and the amount of different numbers used is minimal (see graph 800 of FIG. 8 for illustration). The final result of this operation is a set of created “dummy users” where each of them is defined by the role-number pair corresponding to the role and number assigned to the activities (see FIG. 8 for illustration). Accordingly, the optimal user-activity assignment for a deadlock free execution of this workflow is given next (e.g., as result of detailed operation 320 of method 302).

$${UAA}_{eLaw} = \{ ( {a}_{1} , {u}_{C \text{-} 2} ) , ( {a}_{2} , {u}_{C \text{-} 1} ) , ( {a}_{3} , {u}_{C \text{-} 1} ) , ( {a}_{5} , {u}_{C \text{-} 1} ) , ( {a}_{7} , {u}_{C \text{-} 1} ) , ( {a}_{9} , {u}_{P \text{-} 1} ) , ( {a}_{10} , {u}_{Ch \text{-} 1} ) , ( {a}_{11} , {u}_{C \text{-} 1} ) , ( {a}_{12} , {u}_{C \text{-} 1} ) \}$$

For illustration, the sets of registered users with their role are listed next as well as and their absolute values.

RU_{C}={U_{C-1}, U_{C-2}, U_{C-3}};

min_user(G′_{eLaw}, C)=|RU_{C}|=3;

RU_{P}={u_{P-1}};

min_user(G′_{eLaw}, P)=RU_{P}|=1;

RU_{Ch}={U_{Ch-1}};

min_user(G′_{eLaw}, Ch)=|RU_{Ch}|=1;

This result states that the above given workflow for the change of a law in Austria needs at least 3 users assigned to the role ‘Clerk’, and one user each for the roles ‘President’ and ‘Chancellor’ (e.g., as a result of operation 322 of method 302).

For the execution of the workflow during run-time, a general check whether the roles have enough available members compared to the above calculated minimal needed users (e.g., as a result of operation 328 of method 302).

Assume, for instance, the role Clerk has four members (C={c₁, c₂, C₃, C₄}), and the roles President and Chancellor have one each (P={p₁}, Ch={ch₁}). Finally a mapping from the generic registered users (“dummy users”) given above to real members of the roles may be performed. We basically assign a member of the roles to a distinct dummy user (e.g., c₁→u_{C-1}, c₂→u_{C-2}, C₃→U_{C-3}, p₁→u_{P-1}, ch₁→U_{Ch-1}). A real user is only mapped once to a dummy user. This mapping, together with the user-task assignment UAA_{eLaw} given above, results in an assignment of real users to the tasks of the process. Choosing this user-task assignment (e.g., operation 330 of method 302) results in a deadlock free process execution.

### Modules, Components and Logic

Certain embodiments are described herein as including logic or a number of modules, components or mechanisms. A module, logic, component or mechanism (herein after collectively referred to as a “module”) may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses that connect the modules). In embodiments in which multiple modules are configured or instantiated at different times, communications between such modules may be achieved, for example, through the storage and retrieval of information in memory structures to which the multiple modules have access. For example, a one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

### Electronic Apparatus and System

Example embodiments may be implemented using digital electronic circuitry, or in computer hardware, firmware, software, or in combinations of them. Example embodiments may be implemented using a computer program product, e.g. a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

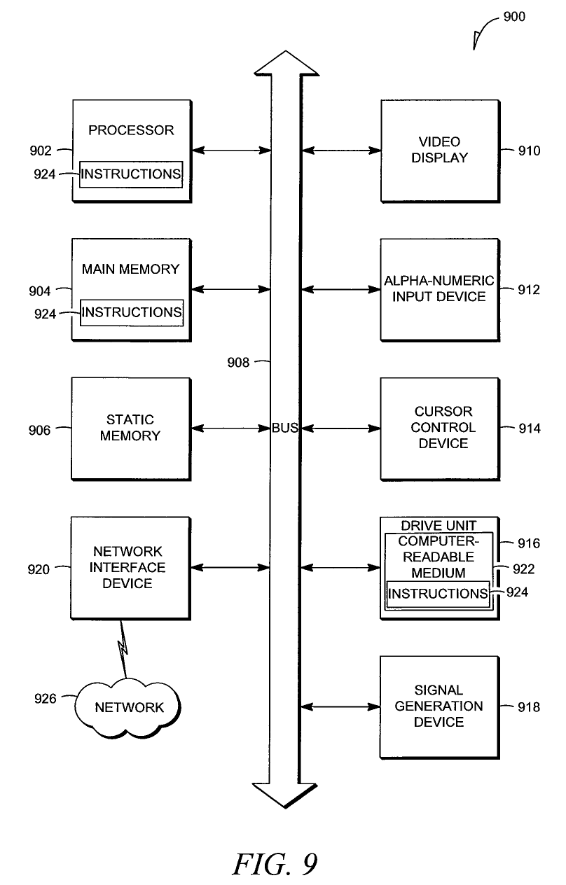

FIG. 9 is a block diagram of machine, in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 924 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks) The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
retrieving information describing a workflow including tasks, roles assigned to the tasks and security constraints related to the tasks;
automatically generating at least one data structure representative of relationships between the tasks and the security constraints; and
performing an automated, design-time evaluation, using the at least one data structure, to determine a minimal number of resources to be assigned to the roles in order to execute the tasks of the workflow and to avoid deadlock in execution of the tasks of the workflow as a result of the security constraints.

2. The computer-implemented method of claim 1, wherein the workflow is a business process, the tasks are business process activities, and the security constraints are at least one of a separation of duty constraint or a binding of duty constraint.

3. The computer-implemented method of claim 1, wherein the automated generation of the at least one data structure includes reflecting, in the at least one data structure, a relationship between the first and second tasks of the workflow having a common security constraint.

4. The computer-implemented method of claim 1, wherein the automated generation of the at least one data structure includes removing a first security constraint relating third and fourth tasks of the workflow to which different roles are assigned.

5. The computer-implemented method of claim 1, wherein the automated generation of the least one data structure includes:
identifying multiple role assignments with respect to a task of the workflow;
generating multiple data structures based on the at least one data structure, each of the multiple data structures representing a single role assignment of the multiple role assignments with respect to the task of the workflow.

6. The computer-implement method of claim 5, wherein the at least one data structure is a constraint-based relation graph which reflects the relationship between the common security constraint and the first and second tasks of the workflow.

7. The computer-implemented method of claim 6, wherein the generating of the multiple data structures comprises transforming the constraint-based relation graph into a set of graphs, each graph of the set of graphs having a unique set of role-task assignments.

8. The computer-implemented method of claim 7, wherein the performance of the automated, design-time evaluation includes applying at least one of graph coloring, general operations research or search algorithms to each graph of the set of graphs to identify a number of resources to be assigned to each role

9. The computer-implemented method of claim 1, wherein the performance of the automated, design-time evaluation includes generating a set of placeholder resources to be assigned to the tasks as placeholders for a later mapping of at run-time available resources.

10. The computer-implemented method of claim 1, including, at run-time:
performing a determination whether the minimal number of resources are available to be assigned to the roles in order to avoid deadlock in the execution of the tasks of the workflow; and
assigning actual resources to the roles.

11. The computer-implemented method of claim 1, including, at run-time, executing the tasks of the workflow.

12. A computer-implemented system comprising:
a first component to retrieve information describing a workflow including tasks, roles assigned to the tasks and security constraints related to the tasks, and to automatically generate at least one data structure representative of relationships between the tasks and the security constraints; and
a second component to perform an automated, design-time evaluation, using the at least one data structure, to determine a minimal number of resources to be assigned to the roles in order to execute the tasks of the workflow and to avoid deadlock in execution of the tasks of the workflow as a result of the security constraints.

13. The computer-implemented system of claim 12, wherein the workflow is a business process, the tasks are business process activities, and the security constraints are at least one of a separation of duty constraint or a binding of duty constraint.

14. The computer-implemented system of claim 12, wherein the second component is to generate the at least one data structure to reflect a relationship between the first and second tasks of the workflow having a common security constraint.

15. The computer-implemented system of claim 12, wherein the second component is automatically to generate the at least one data structure by removing a first security constraint relating third and fourth tasks of the workflow to which different roles are assigned.

16. The computer-implemented system of claim 12, wherein the second component is automatically to generate the at least one data structure by:
identifying multiple role assignments with respect to a task of the workflow;
generating multiple data structures based on the at least one data structure, each of the multiple data structures representing a single role assignment of the multiple role assignments with respect to the task of the workflow.

17. The computer-implement system of claim 16, wherein the at least one data structure is a constraint-based relation graph which reflects the relationship between the common security constraint and the first and second tasks of the workflow.

18. The computer-implemented system of claim 16, wherein the generating of the multiple data structures comprises transforming the constraint-based relation graph into a set of graphs, each graph of the set of graphs having a unique set of role-task assignments.

19. The computer-implemented system of claim 18, wherein the second component is to applying at least one of graph coloring, operations research or search algorithms to each graph of the set of graphs to identify a number of resources to be assigned to each role

20. The computer-implemented system of claim 12, wherein the second component is to generate a set of placeholder resources to be assigned to the tasks as placeholders for a later mapping of at run-time available resources.

21. The computer-implemented system of claim 12, including a third component to:
perform a determination whether the minimal number of resources are available to be assigned to the roles in order to avoid deadlock in the execution of the tasks of the workflow; and
assign actual resources to the roles.

22. The computer-implemented system of claim 12, including a fourth component, at run-time, to execute the tasks of the workflow.

23. A computer system comprising:
a memory; and
a processor, communicatively coupled to the memory, to:
retrieve information describing a workflow including tasks, roles assigned to the tasks and security constraints related to the tasks;
automatically generate at least one data structure representative of relationships between the tasks and the security constraints; and
perform an automated, design-time evaluation, using the at least one data structure, to determine a minimal number of resources to be assigned to the roles in order to execute the tasks of the workflow and to avoid deadlock in execution of the tasks of the workflow as a result of the security constraints.

24. A machine-readable medium storing instructions that, when executed by a processor, cause the processor to:
retrieve information describing a workflow including tasks, roles assigned to the tasks and security constraints related to the tasks;
automatically generate at least one data structure representative of relationships between the tasks and the security constraints; and
perform an automated, design-time evaluation, using the at least one data structure, to determine a minimal number of resources to be assigned to the roles in order to execute the tasks of the workflow and to avoid deadlock in execution of the tasks of the workflow as a result of the security constraints.
